(19) United States
(12) Patent Application Publication
(10) Pub. No.: US 2012/0047495 A1
(43) Pub. Date: Feb. 23, 2012

(54) EXECUTION ENVIRONMENT SUPPORT FOR REACTIVE PROGRAMMING

(75) Inventors: Henricus Johannes Maria Meijer, Mercer Island, WA (US); Gavin Bierman, Cambridge (GB)

(73) Assignee: MICROSOFT CORPORATION, Redmond, WA (US)

(21) Appl. No.: 12/858,895

(22) Filed: Aug. 18, 2010

(51) Int. Cl. G06F 9/45; G06F 9/44

(52) U.S. Cl. 717/140; 712/220

(57) ABSTRACT

An execution environment is created or extended to include support for coroutines to facilitate reactive programming. Utilizing functionality provided by an execution environment, such as a virtual machine, additional operations are derived to enable creation, invocation, and suspension of coroutines.

### BACKGROUND

Reactive programming is becoming increasingly prevalent in modern computer applications. Also referred to as asynchronous or event-based programming, reactive programming pertains to development of programs that are responsive to things that occur at arbitrary times or asynchronously. Traditional synchronous programming produces programs with operations that are time dependent such that a first task needs to be completed before second task is executed, etc. By contrast, asynchronous or reactive programming employs operations that can occur without a regular time relation to other operations.

In the context of modern multi-core and distributed, or cloud, computing, reactive programming is beneficial. In these cases, work is distributed across two or more cores or computers. If synchronous operations are employed, work on a first core or computer may have to stop and wait for a response from a second core or computer. Operating asynchronously, however, eliminates waiting and allows parallel execution across computational entities. Furthermore, a reactive program is receptive to data or the like being pushed to it at arbitrary times by another core or computer, for example.

Unfortunately, for programmers, developing asynchronous or reactive applications is not easy. In particular, current approaches force programmers into a continuation passing style that requires breaking their code into many disjoint event handlers. Other technologies have been proposed to aid the programmer most of which perform a source-to-source transformation of a program or portion thereof to enable a unit of code to be stopped and resumed while maintaining its full state. In effect, the program is transformed into a state machine by way of code injection.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to facilitating reactive programming utilizing an execution environment. Rather than performing source-to-source transformations, an execution environment, such as a virtual machine, can be created or extended to support coroutines, which are generalized subroutines that allow multiple points of entry and exit as well as suspending and resuming of execution at particular locations. Standard execution environment functionality can be exploited to afford more efficient and complete support for restartable code than is possible with higher-level source-to-source transformations. In fact, and in accordance with an aspect of this disclosure, an execution environment can be extended with a limited number of operations associated with creating, invoking, and suspending a coroutine. Program code or portions thereof can be subsequently mapped to coroutine operations provided by the execution environment to enable reactive programming.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates reactive programming.

FIG. 2 is a block diagram of a representative coroutine-operation component.

FIG. 3 is a graphical illustration of an exemplary call-chain scenario.

FIG. 4A graphically illustrates coroutine creation and invocation.

FIG. 4B graphically depicts coroutine creation and invocation.

FIG. 5 graphically depicts suspension of a coroutine.

FIG. 6 is a flow chart diagram of a method of interacting with coroutines.

FIG. 7 is a flow chart diagram of a method of invoking a coroutine.

FIG. 8 is a flow chart diagram of a method of suspending a coroutine.

FIG. 9 is a flow chart diagram of a method of generating a reactive program.

FIG. 10 is a schematic block diagram illustrating a suitable operating environment for aspects of the subject disclosure.

### DETAILED DESCRIPTION

Details below are generally directed toward facilitating reactive programming. An execution environment, such as a virtual machine, is created or extended to include support for coroutines, which are generalized subroutines that allow multiple points of entry and exit as well as suspending and resuming of execution at particular locations. Utilizing functionality provided by the execution environment, operations can be derived for creating, invoking, and suspending coroutines. As a result, program code can be mapped to coroutines to allow the code to be suspended and restarted. For example, imperatively specified code with sequential control flow can be mapped to coroutines by a compiler or like mechanism to automatically generate reactive code.

Injecting support for coroutines into the execution environment is more efficient and complete than source-to-source transformations. Conventionally, complicated transformations are performed, for instance, to turn a program into a state machine that can be stopped and resumed while maintaining full program state. This is consistent with a trend and a desire to implement code at a high level of abstraction, where possible. Essentially, however, execution environment functionality, such as a stack and stack interaction, is inefficiently simulated in a high-level programming language. Further yet, simulations are limited by language features and can thus be incomplete. For example, a nested or recursive call-chain may not be able to be suspended.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

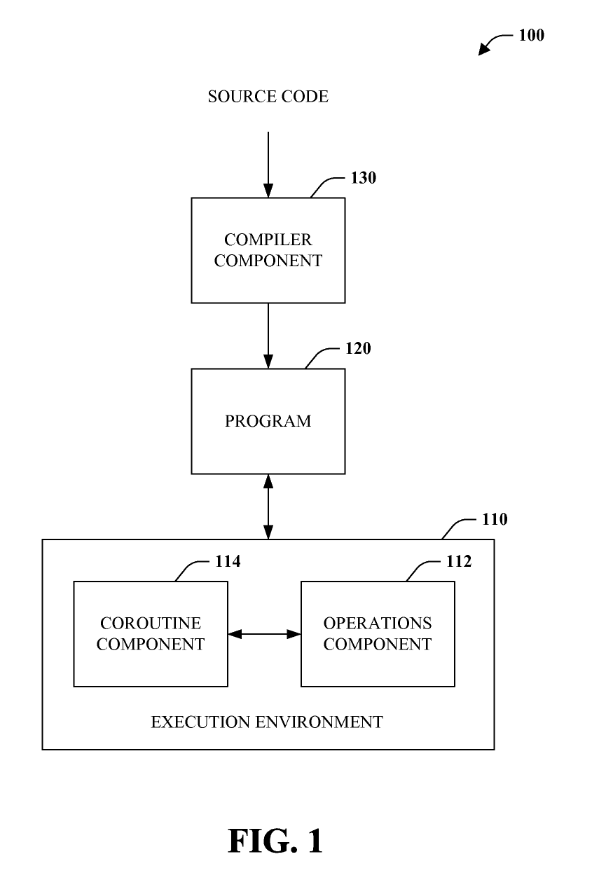

Referring initially to FIG. 1, a system 100 is illustrated that facilitates reactive programming. The system 100 includes an execution environment 110 (can be a component as defined later herein) that accepts commands as input and causes them to be executed. In accordance with one embodiment, the execution environment 110 can be a virtual machine (e.g., Java Virtual Machine (JVM), Common Language Runtime (CLR) . . . ), which provides a platform-independent execution environment that abstracts away details of underlying hardware and software and enables a program to execute the same way on any platform.

The execution environment 110 includes an operations component 112 and a coroutine component 114. The operations component 112 provides or corresponds to standard or native execution environment operations (e.g., loading variables, object creation, method invocation . . . ). The coroutine component 114 extends the functionality provided by operations component 112 to include support for coroutine operations. In one instance, coroutine operations can be derived from the standard or native execution environment operations.

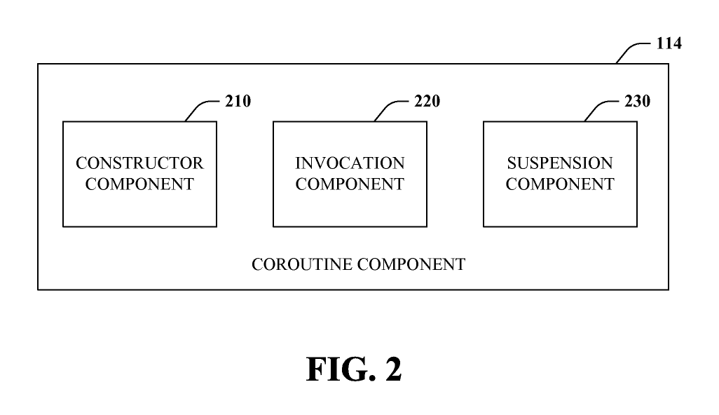

Turning briefly to FIG. 2, a coroutine component 114 is depicted in further detail. As shown, the coroutine component 114 includes a constructor component 210, an invocation component 220, and a suspension component 230. The constructor component 210 generates an executable and suspendable coroutine object in one implementation comprising one or more frames representing computational procedures (e.g., functions, methods . . . ) as well as information about a coroutine (e.g., return address, arguments . . . ). The invocation component 220 includes functionality to call, invoke, or in other words initiates execution of a constructed coroutine. The suspension component 230 can suspend or, stated differently, pause execution of a coroutine. Subsequently, execution can be restarted by way of invocation component 220. However, unlike initial invocation, the coroutine will be restarted just after the where the coroutine was previously suspended.

Returning back to FIG. 1, the execution environment can expose both standard and extended coroutine operations as callable instructions. A computer program 120 can be specified that calls such instructions to enable code to be suspended and restarted. Moreover, it is to be appreciated that the computer program 120 can be constructed by a compiler component 130 that maps input source code (e.g., assembly, library . . . ) to operations provided by the execution environment 110 including coroutine operations. Moreover, source code can be encoded in a manner in which programmers are comfortable, namely imperatively specified code with sequential control structure. Subsequently, the compiler component 130 can transform the source code to lower-level execution environment code by mapping source code instructions to instructions that can be executed by the execution environment 110.

By way of example and not limitation, a programmer can write a program in his/her favorite language. Rather than being required to specify code that starts, stops, suspends, and resumes, a programmer can identify portions of a program that are to operation in this manner and/or portions can be determined or inferred automatically based on context information, for instance. A compiler can subsequently translate the program to an intermediate language (IL) program with calls to coroutine operations, where needed. A virtual machine can then interpret and execute this program as it was intended to operate while sparing the programmer the burden of manually encoding support for asynchrony.

Similar functionality can be accomplished by performing source-to-source transformations. Here, source code is converted to another form of source code with source language code injected to implement support for reactive programming. For example, a program can be turned into a state machine that can be stopped and resumed while maintaining full program state.

However, source-to-source transformation can be both inefficient and incomplete. Implementing support for coroutines in a program is consistent with the current trend and desire by programmers to avoid lower-level code in favor of higher-level code, where possible, to take advantage of abstractions provided by high-level languages (e.g., C#®, Visual Basic®, Java . . . ). Unfortunately, in this situation higher-level program languages are reintroducing abstractions from a lower level execution environment such as a stack. In other words, execution environment constructs are simulated in a higher-level language, which is not very efficient. Further, such simulations are limited by the expressiveness and functionality of a given language. As a result, source-to-source transformation may not include complete support for asynchrony and more specifically executing, suspending, and restarting code. For example, suspension of a chain of calls may not be enabled.

By contrast, creating or extending an execution environment 110 to include support for coroutines is much more efficient and complete than source-to-source translations. In particular, most execution environments provide support for stacks, which can be used to implement coroutines efficiently and more completely. Furthermore, and in accordance with one embodiment, support for coroutines can be implemented by adding three instructions as will be described further hereinafter. Additionally, where an execution environment 110 supports interaction from a plurality of source programming languages, the advantages are distributed to each language thereby avoiding the cost of implementing a source-to-source transformation for each language. For example, source-to-source transformations are generated for each of two programming languages. By contrast, an execution engine can be extended once, and it can support both of the two programming languages when compiled to intermediate language code, for instance.

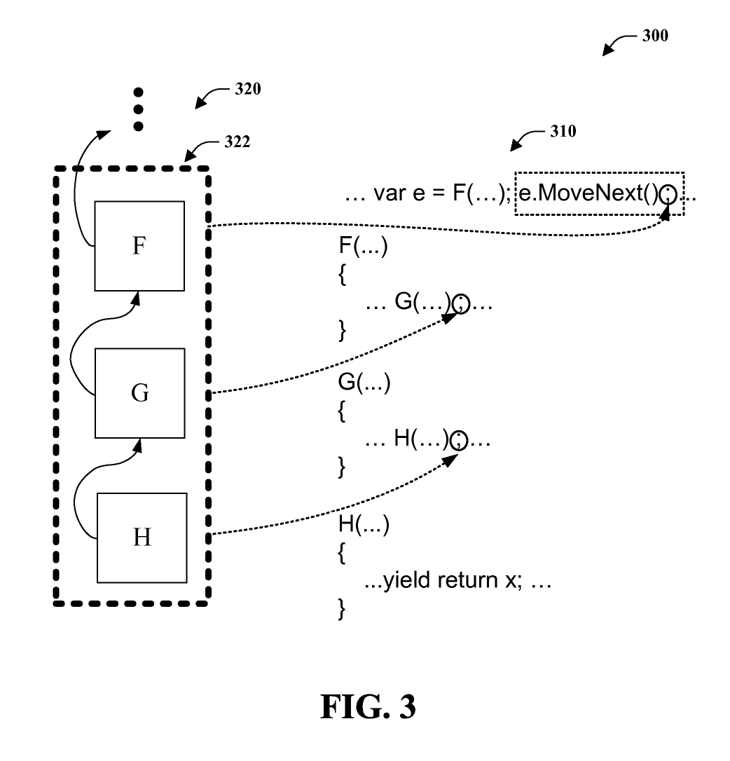

FIG. 3 illustrates a call chain scenario 300 that is supported by creating or extending an execution environment 110 (FIG. 1) to support coroutines. Code snippet 310 illustrates a call chain with three functions “F,” “G,” and “H” in which “F” calls “G,” “G” calls “H,” and a yield return (e.g., suspend or pause) is located inside “H.” Conventional naïve source-to-source translations do not allow for nested yielding and resumption of control. That is, one cannot suspend a complete (e.g., recursive) call chain. Here, starting after first calling “F” to create an enumerator it is desired that the whole call chain be suspended up to the call to “MoveNext( )” from inside the call to “yield return” inside function “H.” While in theory it may be possible to implement this desired behavior using source-to-source transformations, it is actually much easier to achieve with a lower level of abstraction where there is direct access to stack frames and return addresses, for instance. More particularly, a stack 320 (also known as a frame stack) can be employed. Here, a coroutine, or more specifically a coroutine object, 322 can be created that captures frames corresponding to the partial call-chain of functions “F,” “G,” and “H.” As well, a return address is provided for the top-most frame in this example specifying a location to which to return after execution of the coroutine.

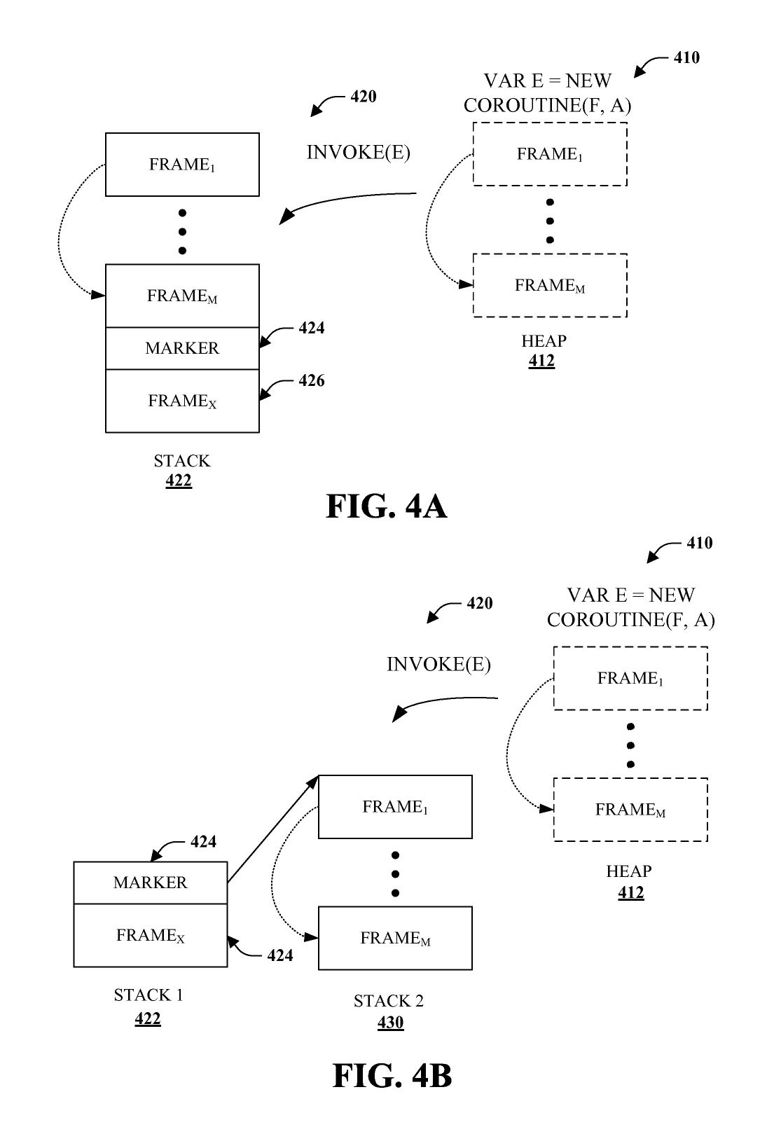

FIG. 4A graphically illustrates creation of a coroutine or coroutine object and invocation thereof in accordance with one embodiment. As shown, a new coroutine “E” 410 is created by executing the following code “var E=new Coroutine(F, A)” where there is stack frame for function or code “F” denoted as “FRAME₁ to FRAME_{M},” where “M” is an integer greater than equal to one, and “A” represents arguments for the function or code “F.” The coroutine 410 is initially stored in heap 412. Further, note the coroutine 410 can represent a call chain series or partial call chain series including recursion, for example, which is indicated by the dashed arrow between “FRAME₁” and FRAME_{M}″ and similar to the scenario of FIG. 3.

Subsequently, the coroutine 410 can be invoked by calling the code “Invoke(E)” 420, for example. At this time, the coroutine 410 is moved to the execution stack, or simply, stack 422, to allow execution thereof. However, prior to pushing or winding the coroutine onto the stack 422, a marker 424 (e.g., −1) can be pushed onto the stack 422 to delineate the coroutine from other stack frames previously pushed on the stack 422, such as “FRAME_{X}” 426.

FIG. 4B depicts another embodiment of coroutine creation and invocation. Similar to FIG. 4A, a new coroutine, or coroutine object, 410 can be constructed on the heap 412 by execution such code as “var E=new Coroutine(F,A)” where “F” represents code and “A” is the arguments for that code. Again, coroutine execution can be initiated with such an instruction as “Invoke(E)” 420. Here, however, the marker 424 (e.g., −1) can be pushed to the stack 422 (STACK 1) and the coroutine 410 can be pushed a second stack 430 (STACK 2). The marker 424 then points to the location of the coroutine on second stack 430 and as such initiates execution from the beginning of the coroutine or some other location following a pause in execution.

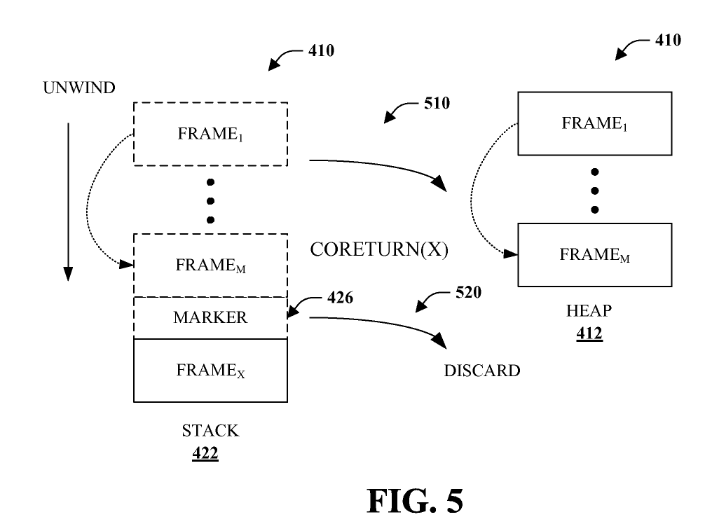

FIG. 5 graphically depicts coroutine suspension. For purposes of brevity, FIG. 5 illustrates suspension with respect to invocation as provided in FIG. 4A. One of skill in the art upon reading this description will understand how to adapt suspension for other embodiments including but not limited to the embodiment illustrated in FIG. 4B. To suspend or pause execution an instruction such as, but not limited to, “Coreturn(x)” 510 can be called, which stops execution and causes the coroutine 410 to be popped off the stack 422 and saved along with coroutine state to the heap 412. More particularly, the coroutine 410 can be unwound up to the marker 424, and the marker 424 can be discarded 520, thereby transferring control back to some other code, such as the caller of the coroutine. Furthermore, it should be appreciated that upon suspension the coroutine can pass back some value to the stack 422 (not shown).

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the compiler component 130 can employ such mechanisms determine or infer if and when source code or portions thereof should be mapped to coroutine operations of an execution environment to provide reactive or in other words asynchronous functionality.

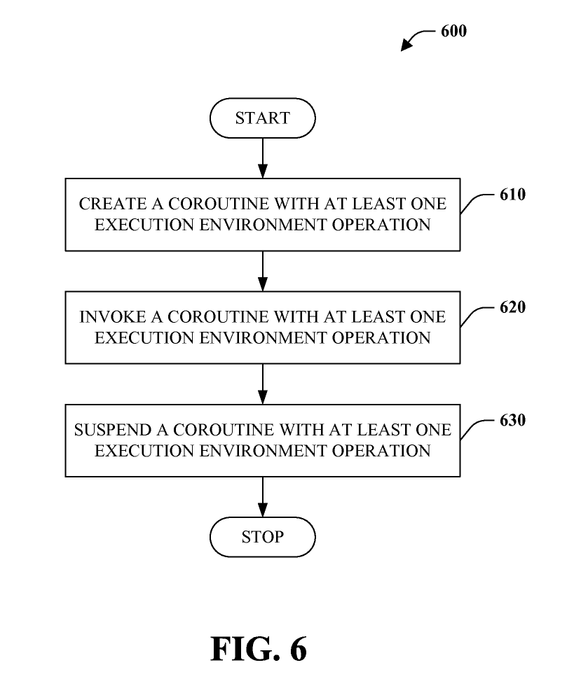

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a method of interacting with coroutines 600 is illustrated. At reference numeral 610, a coroutine is created or otherwise constructed by calling at least one execution environment operation such as “new Coroutine( )” At numeral 620, execution of a constructed coroutine is initiated, or in other words, invoked, utilizing at least one execution environment operation such as “Invoke( )” for instance. At reference numeral 630, execution of a coroutine can be suspended by calling at least one execution environment operation, for example “Coreturn( )” In accordance with one embodiment, coroutines can be implemented within an execution environment by simply employing the three operations mentioned above. Of course, the claimed subject matter is not so limited and any number of instructions or operations can be utilized.

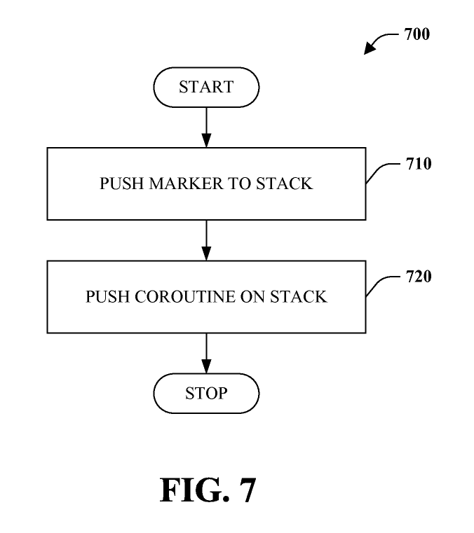

FIG. 7 is a flow chart diagram of a method of invoking a coroutine 700 in accordance with one embodiment. At reference numeral 710, a marker is pushed onto a call stack, or in other words an execution stack. The marker can have a special value such as negative one to indicate the boundary of a coroutine. At numeral 720, a coroutine is pushed on the same stack (a first stack) following the marker or a different stack (a second stack) where the marker provides a pointer thereto. For example, the coroutine can be moved from a heap, where it was stored after creation, to a stack. The coroutine can include procedures (e.g., functions, methods . . . ) to be executed, and by placing the coroutine on the stack, execution is automatically initiated.

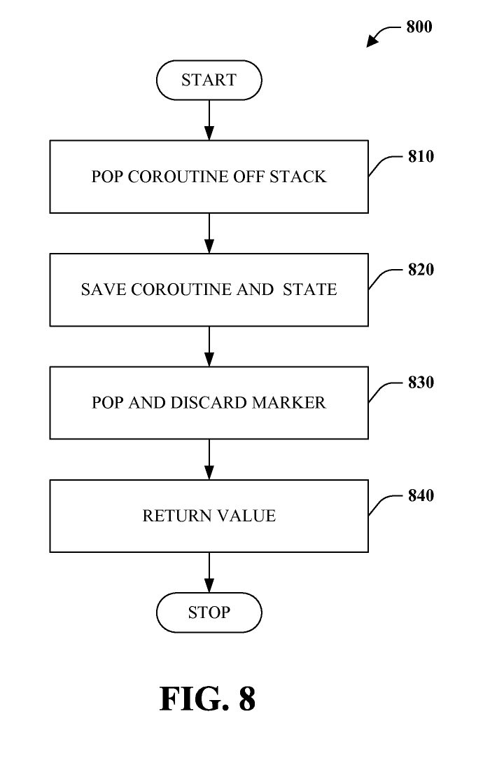

FIG. 8 is a method of program suspension 800. At reference numeral 810, a coroutine is popped off a stack or stated differently is unwound from the stack. At 820, the coroutine and coroutine state (e.g., current values of variables, arguments . . . ) associated therewith are saved, for example on a heap. At numeral 830, a marker noting a coroutine boundary on a stack, which in one embodiment can also point to a coroutine on another stack, is popped of the stack and discarded. At reference numeral 840, a value associated with execution is returned or more particularly, the value can be saved to the execution stack.

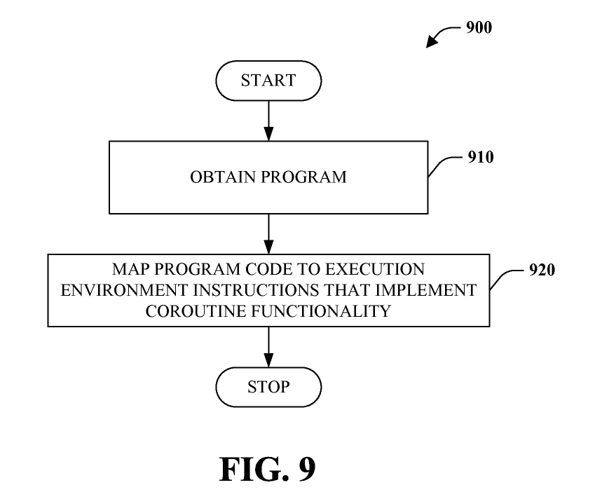

Referring to FIG. 9, a flow chart diagram of a method of generating a reactive program 900 is depicted. At reference numeral 910, a source program is received, retrieved, or otherwise obtained or acquired. For example, the program can be specified in a high-level language such as C#®, Visual Basic®, or the like. Moreover, the obtained program can be specified with a sequential control flow. At reference numeral 820, program code is mapped to execution environment instructions and thus operations that implement coroutine functionality (e.g., new Coroutine( ), Invoke( ), Coreturn( )). In accordance with one embodiment, all or portions of code can be made reactive based on known or inferred information about a program, context, or the like. For example, where code can be determined or inferred to request and wait for a response from another computational entity such as a server, such code can be made reactive by mapping to instructions that implement coroutine functionality.

What follows are some sample transition rules or operational semantics that can be employed to give a high-level, mathematical specification of an exemplary execution environment such as a virtual machine. The execution environment can include a plurality of instructions for loading constants on a stack, loading arguments, creating new objects, performing field access, performing a call, performing a virtual call, performing a return, creating a new coroutine, invoking a coroutine, and suspending a coroutine, among other things.

An execution environment configuration can be written “H├FS,” where “H” is a heap and “FS” is a frame stack. The heap, “H,” is represented as a function from object identifiers to runtime objects. A runtime object is written “<<T, F>>” where “T” is a type and “F” is a field map (a function from field names to values).

A frame stack is a stack of frames. To denote stack concatenation “∘” is used; so a stack with a head “h” and tail “t” is written “t∘h.” The symbol “[ ]” is overloaded to denote both the empty stack and an empty array. A frame is represented as a 4-tuple and written “ [symbol] pc, L, A, E [symbol] .” The first “pc” is the program counter, which is an index into the fixed program store, “Prog.” The second component “L” is an array of local variables. (An array is written, for example, [a₀, a₁, . . . , aₙ].“). The third component, “A,” is an array of arguments. The fourth component “E” is an execution stack (often referred to as simply the stack).

Evaluation rules for this exemplary execution environment are written as transition rules between execution environment configurations.

$$“ H ⊢ FS \cdot 〈 pc , L , A , E 〉 {\to }^{i} H ⊢ {FS}^{′} ”$$

is written as shorthand for “H├FS∘ [symbol] pc, L, A,E [symbol] →H├FS'” where “Prog[pc]=i,” where “i” is the instruction at location “pc” in the program store “Prog.” Some representative evaluation rules are given below.

Further, the frame “ [symbol] invoke, [ ], [ ], [o] [symbol] ” is a special marker frame used by the coroutine instructions. One potentially appropriate value for invoke would be negative one (“−1”).

$$\begin{matrix}H ⊢ FS \cdot 〈 pc , L , A , E 〉 {\to }^{ldc . i 4 i 4} H ⊢ FS \cdot 〈 pc + 1 , L , A , E \cdot i 4 〉 & Rule 1 \\ H ⊢ FS \cdot 〈 pc , L , A , E 〉 {\to }^{ldc . i 8 i 8} H ⊢ FS \cdot 〈 pc + 1 , L , A , E \cdot i 8 〉 & Rule 2 \\ H ⊢ FS \cdot 〈 pc , L , A , E 〉 {\to }^{ldarg i} H ⊢ FS \cdot 〈 pc + 1 , L , A , E \cdot A [ i ] 〉 & Rule 3 \\ H ⊢ FS \cdot 〈 pc , L , A , E \cdot {v}_{1} \cdot … \cdot {v}_{n} 〉 {\to }^{newobj I} H ⊢ FS \cdot 〈 pc + 1 , L , A , E 〉 \cdot 〈 {pc}_{c} , {L}_{c} , [ o , {v}_{1} , … , {v}_{n} ] , [ ] 〉 , \\ where constructor ( I ) = {pc}_{c} , locals ( I ) = {L}_{c} , and o ∉ dom ( H ) & Rule 4 \\ H ⊢ FS \cdot 〈 pc , L , A , E \cdot o 〉 {\to }^{ldfld T I ∷ f} H ⊢ FS \cdot 〈 pc , L , A , E \cdot F ( f ) 〉 , \\ where H ( o ) = << T , F >> & Rule 5 \\ H ⊢ FS \cdot 〈 pc , L , A , E \cdot o \cdot {v}_{1} \cdot … \cdot {v}_{n} 〉 {\to }^{callvirt M} H ⊢ FS \cdot 〈 pc + 1 , L , A , E 〉 \cdot 〈 {pc}_{m} , {L}_{m} , [ o , {v}_{1} , … , {v}_{n} ] , [ ] 〉 , \\ where H ( o ) = << T , F >> , mbody ( T , M ) = {pc}_{m} , and locals ( T , M ) = {L}_{m} & Rule 6 \\ H ⊢ FS \cdot 〈 {pc}^{′} , {L}^{′} , {A}^{′} , {E}^{′} 〉 \cdot 〈 pc , L , A , E \cdot v 〉 {\to }^{ret} H ⊢ FS \cdot 〈 {pc}^{′} , {L}^{′} , {A}^{′} , {E}^{′} \cdot v 〉 , & Rule 7 \\ H ⊢ FS \cdot 〈 pc , L , A , E \cdot o \cdot {v}_{1} \cdot … \cdot {v}_{n} 〉 {\to }^{newcoroutine M} H ⊢ FS \cdot 〈 pc + 1 , L , A , E \cdot {o}^{′} 〉 , \\ where H ( o ) = << T , F >> , mbody ( T , M ) = {pc}_{m} , locals ( T , M ) = {L}_{m} , {o}^{′} ∉ dom ( H ) , and {H}^{′} = H [ {o}^{′} ↦ 〈 〈 CR , state ↦ 〈 {pc}_{m} , {L}_{m} , [ o , {v}_{1} , … , {v}_{n} ] , [ ] 〉 〉 〉 ] & Rule 8 \\ H ⊢ FS \cdot 〈 pc , L , A , E \cdot o 〉 {\to }^{invoke} H ⊢ FS \cdot 〈 pc + 1 , L , A , E 〉 \cdot 〈 invoke , [ ] , [ ] , [ o ] 〉 \cdot {FS}^{′} , where H ( o ) = CR , state ↦ {FS}^{′} >> & Rule 9 \\ H ⊢ FS \cdot 〈 {pc}^{′} , {L}^{′} , {A}^{′} , {E}^{′} 〉 \cdot 〈 invoke , [ ] , [ ] , [ o ] 〉 \cdot {FS}^{′} \cdot 〈 pc , L , A , E \cdot v 〉 {\to }^{coret} H ⊢ FS \cdot 〈 {pc}^{′} , {L}^{′} , {A}^{′} , {E}^{′} \cdot v 〉 , where 〈 invoke , [ ] , [ ] , [ ] 〉 ∉ {FS}^{′} , and {H}^{′} = H [ o ↦ 〈 〈 CR ↦ {FS}^{′} \cdot 〈 pc + 1 , L , A , E 〉 〉 〉 ] \\ & Rule 10 \\ H ⊢ FS \cdot 〈 pc , L , A , E 〉 {\to }^{coret} YieldException if 〈 invoke , [ ] , [ ] , [ ] , 〉 ∉ FS & Rule 11\end{matrix}$$

Rule 1 states that there is a heap and a frame stack, and the top frame on the stack has four things, namely program counter (pc), an array of local variables (L), an array of arguments(A), and an evaluation stack (E). The program counter points to some location in the program. In other words, the program counter is an index into the program. The long arrow indicates that what the program counter points to in the program is the instruction that is written above the arrow. Here, the instruction is load a 4-byte integer constant (ldc) “i4.” The effect on the execution environment is that the program counter is incremented and the constant “i4” is added to the top of the evaluation stack.

Rule 2-5 are fairly similar. For example, Rule 2 concerns loading an 8-byte integer constant, and Rule 3 pertains to loading argument “i” from the argument array “A” onto the execution stack. Rule 4 generates a new object, and Rule 5 loads a field. Further, Rule 7 concerns returning a value. These are common execution environment instructions.

Rule 6 pertains to calling a virtual method. The rule says to pre-load the address of the object you want to call the virtual method on the evaluation stack as well as the arguments. If the next instruction is “callvirt M,” where “M” is the name of the method called, then a fresh frame is installed on top of the frame stack. This frame contains the address of the first instruction of the method, fresh instances of the locals of the method and an argument array containing the arguments passed to the method call (including the address of the object in position zero of the argument array). In other words, a new frame is constructed and pushed to the top of the frame stack, and the next thing that will happen is method execution or evaluation.

Rule 8 concerns construction of a new coroutine and is similar to Rule 6. Basically, a fresh object is created that has the address “o” and that has type coroutine, which is denoted here “CR.” Next, coroutine state is loaded which is indicated as a field, but of course, here a coroutine is represented by a frame (e.g., a piece of paused execution). In sum, an object representing the suspended coroutine is created.

The next execution rule, Rule 9, relates to invocation of a coroutine, or more particularly a coroutine object. When created, the coroutine representation can reside on a heap. Upon receipt of an invoke instruction the coroutine can be moved to the top of the frame stack which has the effect of un-suspending execution of the coroutine. If the coroutine has not been executed before, execution will begin at the first instruction. Otherwise, execution will begin at the next instruction after it was previously suspended. It should be noted that to the right of the invoke arrow there is the original frame stack (FS) and the coroutine frame stack (FS′). However, between these two frame stacks there is a special marker [symbol] invoke, [ ], [ ],[o] [symbol] that provides a boundary between the original and coroutine frame stacks. It also includes the address in the heap,” o,” where the coroutine can be stored.

Rule 10 pertains to the “coreturn” or as it is written here “coret” instruction that suspends execution of a coroutine. The intention is to suspend the work of the coroutine, store its current state back into a heap and return execution to the caller of the coroutine. As denoted, after execution of the “coret” instruction, an updated heap “H′” is created that includes the suspended coroutine frame stack (FS'). The marker is then discarded and execution of original calling code can proceed. Notice also that the coreturn operation can return a value “v” which can be put on top of the execution stack.

New error states are also possible. As specified by execution Rule 11, if a marker is not an element of the frame stack and the “coret” instruction is called, an exception can be produced. This is denoted in Rule 11 as simply a special configuration “YieldException.”

As used herein, the terms “component,” “system,” and “environment” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

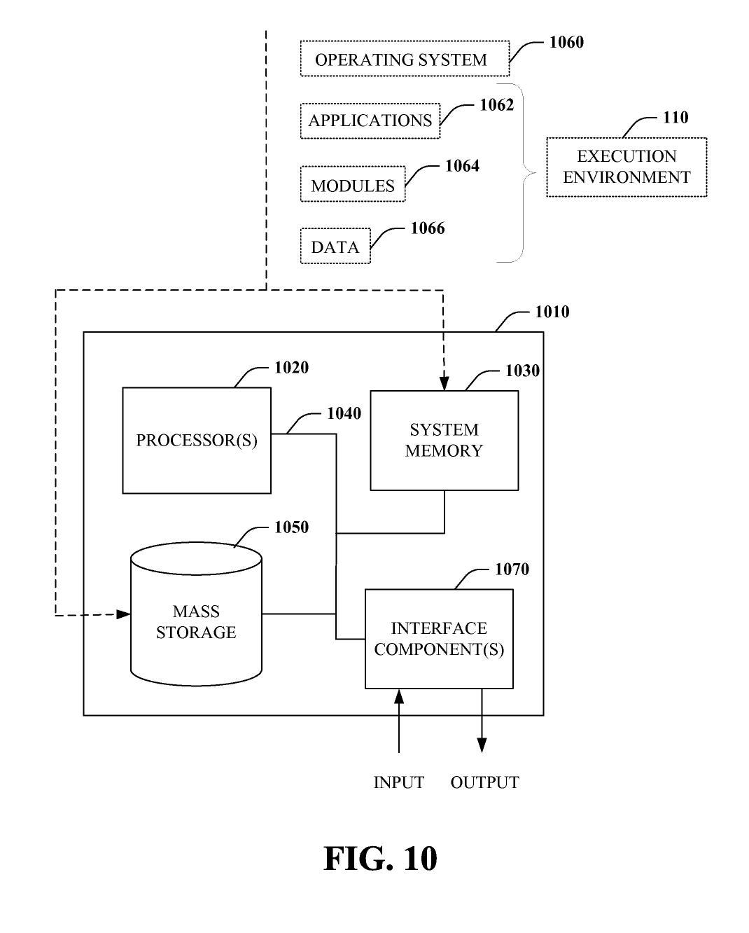

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example computer or computing device 1010 (e.g., desktop, laptop, server, hand-held, programmable consumer or industrial electronics, set-top box, game system . . . ). The computer 1010 includes one or more processor(s) 1020, system memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to system memory 1030 that execute various computer executable actions, instructions, and or components.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

System memory 1030 and mass storage 1050 are examples of computer-readable storage media. Depending on the exact configuration and type of computing device, system memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the system memory 1030. For example, mass storage 1050 includes, but is not limited to, one or more devices such as a magnetic or optical disk drive, floppy disk drive, flash memory, solid-state drive, or memory stick.

System memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in system memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the execution environment 110 can be an application 1062 or part of an application 1062, and include one or more modules 1064 and data 1066 stored in memory and/or mass storage 1050 whose functionality can be realized when executed by one or more processor(s) 1020, as shown.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of reactive programming, comprising:
employing at least one processor configured to execute computer-executable instructions stored in memory to perform the following act:
invoking a coroutine with one or more operations provided by a platform-independent execution environment.

2. The method of claim 1, invoking the coroutine comprises pushing a marker on a stack followed by at least one frame that represents the coroutine.

3. The method of claim 1, invoking the coroutine comprises pushing a marker on a first stack that points to a second stack including at least one frame that represents the coroutine.

4. The method of claim 1, further comprising suspending execution of the coroutine with at least one operation provided by the platform-independent execution environment.

5. The method of claim 4, suspending execution comprising unwinding a stack to a marker and saving the coroutine and coroutine state.

6. The method of claim 4, further comprising restarting execution of the coroutine with at least one operation provided by the platform-independent execution environment.

7. The method of claim 1, generating the coroutine with one or more operations supplied by the platform-independent execution environment.

8. The method of claim 7, further comprising generating the coroutine including two or more chained stack frames.

9. A system that facilitates reactive programming, comprising:
a processor coupled to a memory, the processor configured to execute the following computer-executable components stored in the memory:
a first component configured to provide a platform-independent execution environment that supports execution of one or more coroutines.

10. The system of claim 9, the first component includes three instructions to support execution of a coroutine.

11. The system of claim 10, one instruction creates a coroutine object including at least one frame.

12. The system of claim 10, one instruction initiates execution of a coroutine at a first instruction or a subsequent instruction following a prior suspension of execution.

13. The system of claim 10, one instruction suspends execution of the coroutine and saves the coroutine and coroutine state to enable suspended execution to be resumed.

14. The system of claim 9, the first component is configured to push a marker onto a stack prior to a coroutine.

15. The system of claim 9, the first component is configured to push a marker onto a first stack that points to second stack that includes a coroutine.

16. The system of claim 9, further comprising a second component configured to map imperatively specified code with a sequential control flow to one or more instructions that implement coroutine functionality.

17. A computer-readable medium having instructions stored thereon that perform the following acts when executed:
invoking a coroutine with a first operation provided by a virtual machine.

18. The computer-readable medium of claim 17, further comprising suspending execution of the coroutine with a second operation provided by the virtual machine.

19. The computer-readable medium of claim 18, further comprising restarting execution of the coroutine with the first operation provided by the virtual machine.

20. The computer-readable medium of claim 17, further comprising generating a coroutine with a third operation provide by a virtual machine.
